(19) United States
(12) Patent Application Publication
(10) Pub. No.: US 2025/0224379 A1
(43) Pub. Date: Jul. 10, 2025

(54) SPEED ESTIMATION APPARATUS, EVALUATION SYSTEM, AND SPEED ESTIMATION METHOD

(71) Applicant: KABUSHIKI KAISHA TOSHIBA, Tokyo (JP)

(72) Inventor: Takashi USUI, Saitama Saitama (JP)

(73) Assignee: KABUSHIKI KAISHA TOSHIBA, Tokyo (JP)

(21) Appl. No.: 19/002,418

(22) Filed: Dec. 26, 2024

(30) Foreign Application Priority Data
Jan. 4, 2024 (JP) 2024-000302

(51) Int. Cl. G01N 29/04; G01N 29/07; G01N 29/12

(52) U.S. Cl. CPC G01N 29/045; G01N 29/07; G01N 29/12; G01N 2291/011; G01N 2291/023

(57) ABSTRACT

According to one embodiment, a speed estimation apparatus includes a spectrum information extractor, a peak frequency extractor, a range determiner, a specifier, and an elastic wave speed estimation unit. The spectrum information extractor extracts spectrum information of one or more elastic waves generated due to an impact at different measurement points of a target member for each measurement point. The peak frequency extractor extracts one or more peak frequencies in each of the pieces of spectrum information extracted for each of the measurement points. The range determiner determines a frequency range of the elastic waves based on the one or more peak frequencies. The specifier specifies a peak frequency at each measurement point based on the spectrum information and the frequency range. The elastic wave speed estimator configured to estimate an elastic wave speed at each measurement point based on the peak frequency and thickness information of the target member.

### CROSS-REFERENCE TO RELATED APPLICATION

This application is based upon and claims the benefit of priority from Japanese Patent Application No. 2024-000302, filed Jan. 4, 2024, the entire contents of which are incorporated herein by reference.

### FIELD

Embodiments described herein relate generally to a speed estimation apparatus, an evaluation system, and a speed estimation method.

### BACKGROUND

In recent years, problems associated with aging of industrial apparatuses or structures have become increasingly manifest. Since damage caused due to occurrence of accidents in industrial apparatuses or structures is immeasurable, techniques for monitoring states of the industrial apparatuses or structures have been developed from the past. For example, a method has been proposed to diagnose soundness by making an evaluation in which an elastic wave source density distribution representing a density distribution of each of generation sources of a plurality of elastic waves generated from damage is combined with a speed distribution representing a distribution of speeds of the plurality of elastic waves.

Patent Document 1 discloses a method of quantitatively evaluating soundness using an elastic wave speed distribution and an elastic wave source density distribution. Patent Document 2 discloses an elastic wave tomography for obtaining a speed field distribution by causing elastic waves to be generated in a structure and performing elastic wave tomography analysis with an arrival time difference caused when the elastic waves penetrate through a material. Patent Document 3 discloses a method of causing a plurality of installed elastic wave waveform measurement sensors to receive sounds emitted for a measurement target, performing calculation using a mathematical formula for estimating transmission times and transmission positions of the emitted sounds based on reception times and reception positions specified by the sensors, obtaining estimated transmission times and estimated transmission positions, and performing tomography analysis using values of the obtained estimated transmission times and estimated transmission positions. In Non-Patent Document 1, a method of applying impact elastic waves and calculating elastic wave speeds based on spectrum peaks of elastic waves multi-reflected from an application surface and a bottom surface and a known plate thickness is used.

An inverse analysis tomography method has problems of a calculation cost incurred, for example, because a time is necessary to obtain a result due to a significant calculation load, and it is necessary to change conditions and perform analysis again when convergence fails in the case of a non-uniform structure. There is also a problem that a determination error of an arrival time leads to a speed error and it is difficult to obtain a speed accurately. On the other hand, a method in which multiple reflection of impact elastic waves is used has a problem that a speed can be obtained through simple sequential analysis for a uniform material and it is difficult to specify spectrum peaks corresponding to a known plate thickness for a non-uniform material. In particular, when there are a plurality of locations at which reflection occurs, such as internal reinforcement steels or pavement interfaces on actual road slabs, it is particularly difficult to specify a desired spectrum. Therefore, there are cases in which sufficient speed estimation accuracy cannot be obtained.

### BRIEF DESCRIPTION OF THE DRAWINGS

FIG. 1 illustrates an example of a frequency spectrum of a vibration waveform.

FIG. 2 illustrates an image of multiple reflection in a structure that has an internal void.

FIGS. 3A and 3B illustrate examples of frequency spectra at measurement points A and B.

FIGS. 4A and 4B illustrate overlapping of multiple reflection spectra depending on presence or absence of an internal void.

FIG. 5 illustrates an example of a peak frequency incidence distribution obtained by a simulation in which a reduction in a speed due to an internal void is modeled.

FIG. 6 illustrates an example of a peak frequency incidence distribution including a flexural mode.

FIG. 7 illustrates a method of determining a peak frequency in a frequency range of a plate thickness mode.

FIG. 8 illustrates a configuration of a structure evaluation system according to an embodiment.

FIG. 9 illustrates a configuration example of a signal processor according to the embodiment.

FIG. 10 illustrates a flow of a speed estimation process performed by the signal processor according to the embodiment.

FIGS. 11A and 11B illustrate results obtained by converting a frequency axis in a frequency spectrum obtained at a certain measurement point into a depth direction (thickness direction of a structure).

### DETAILED DESCRIPTION

The present invention provides a problem to be solved by the present invention is to provide a speed estimation apparatus, an evaluation system, and a speed estimation method capable of improving estimation accuracy of an elastic wave speed.

According to one embodiment, a speed estimation apparatus includes a spectrum information extractor, a peak frequency extractor, a range determiner, a specifier, and an elastic wave speed estimator. The spectrum information extractor extracts spectrum information of one or more elastic waves generated due to an impact at different measurement points of a target member for each measurement point. The peak frequency extractor extracts one or more peak frequencies in each of the pieces of spectrum information extracted for each of the measurement points. The range determiner is configured to determine a frequency range of the elastic waves based on the one or more peak frequencies obtained for each of the measurement points. The specifier specifies a peak frequency at each measurement point based on the spectrum information extracted for each of the measurement points and the frequency range. The elastic wave speed estimator estimates an elastic wave speed at each measurement point based on the peak frequency specified for each measurement point by the specifier and thickness information of the target member.

Hereinafter, a speed estimation apparatus, an evaluation system, and a speed estimation method according to embodiments will be described with reference to the drawings.

### (Estimation Principle of Elastic Wave Speed Using Multiple Reflection)

First, before description of content in an embodiment, a principle for estimating an elastic wave speed using multiple reflection will be described. In the related art, as a method of measuring elastic wave speeds, a general method is to obtain a speed based on a difference between arrival times of elastic waves detected by two sensors from which distances are known. However, this method has a problem such as dependence on determination accuracy of an arrival time, a detected speed that is a speed of a surface wave, and non-influence of internal characteristics of a structure. Accordingly, a speed estimation method in which multi-reflection of elastic waves is used has been proposed, as disclosed in Reference Document 1 below.
(Reference Document 1: Nicholas J. CARINO, “Impact Echo: The Fundamentals”, International Symposium Non-Destructive Testing in Civil Engineering (NDT-CE), 15-17 Sep. 2015, Berlin, Germany).

In the method disclosed in Reference Document 1, elastic waves are internally generated by applying an impact with large intensity in a sufficiently broad band to a structure. For the internally generated elastic waves, multi-reflection occurs on internal voids of a structure or air interface. When Cₚ is a speed of an elastic wave (elastic wave speed) propagating internally in a structure, a peak appears at a travel period Δt when the elastic wave propagates at the elastic wave speed Cₚ over double a distance of a plate thickness T of the structure in a vibration waveform detected by the sensors installed on the surface of the structure. Accordingly, a frequency f of observed vibration is expressed as in the following Formula (1).

$$\begin{matrix}[ Math . 1 ] & \\ f = \frac{1}{Δ t} = \frac{{C}_{p}}{2 T} & ( 1 )\end{matrix}$$

That is, when the plate thickness T is known and f is a peak frequency of an elastic wave corresponding to a plate thickness mode in a vibration waveform observed by a sensor, the elastic wave speed Cₚ is expressed as in the following Formula (2). Here, the plate thickness mode means that the elastic wave is reflected from a surface opposite to a surface to which an impact is applied. That is, the elastic wave corresponding to the plate thickness mode is an elastic wave reflected from the surface opposite to the surface to which the impact is applied.

$$\begin{matrix}[ Math . 2 ] & \\ {C}_{p} = 2 Tf & ( 2 )\end{matrix}$$

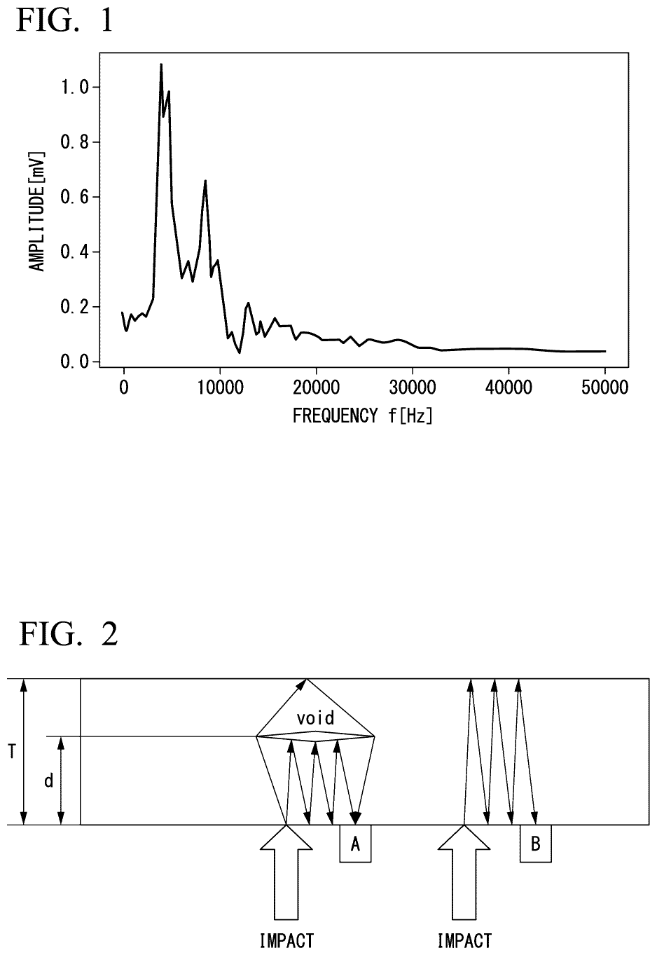

The frequency fin Formula (2) can be obtained by performing fast Fourier Transform (FFT) on the vibration waveform observed by the sensor. In the calculation of the frequency f, another method such as a maximum entropy method (MEM) may be used. However, in a frequency spectrum of a vibration waveform measured for an actual structure, as illustrated in FIG. 1, a plurality of peaks generally arise. FIG. 1 illustrates an example of a frequency spectrum of a vibration waveform. As illustrated in FIG. 1, when the plurality of peaks arise, it is unclear which peak frequency is a peak frequency corresponding to the plate thickness mode. A peak amplitude corresponding to the plate thickness mode is not necessarily large. When there is a void or damage in a shallow location, a portion interposed between surfaces of a structure and voids or the like vibrates at a frequency lower than the frequency f obtained from a relationship of Formula (2). A vibration mode at this time is referred to as a flexural mode. Since vibration at a low frequency appears larger in the flexural mode, a lowest frequency peak is not necessarily the plate thickness mode. In the related art, when a plurality of peaks arise in this way, a peak frequency corresponding to the plate thickness mode cannot be specified and sufficient speed estimation accuracy cannot be obtained. Accordingly, in an embodiment to be described below, a method of specifying a peak frequency corresponding to the plate thickness mode and improving speed estimation accuracy will be described.

### (Method of Estimating Frequency Range of Plate Thickness Mode)

A method of specifying a peak frequency corresponding to the plate thickness mode according to an embodiment will be described. In an actual structure, the elastic wave speed Cₚ has a dispersion since the elastic wave speed Cₚ is affected by non-uniformity, an internal void, damage, or the like of the structure. Here, a case in which there is a void (illustrated in FIG. 2) inside a structure as in FIG. 2 will be considered. As illustrated in FIG. 2, T is a thickness of the structure. At a measurement point A, there is a void at a location of a depth d. At a measurement point B, there is no void. At the measurement point A, multi-reflection (frequency f_{void}) due to the void and multi-reflection (frequency f_{T′}) on an opposite surface bypassing the void occur. A propagation distance at this time increases by an increment ΔT due to the bypass. At the measurement point B, only multi-reflection (frequency f_{T}) on the opposite surface occurs. The peak frequency f_{T} of the multi-reflection on the opposite surface, the peak frequency f_{void} of the multi-reflection due to the void, and the peak frequency f_{T′} of the multi-reflection on the opposite surface bypassing the void are expressed as in the following Formula (3) to (5).

$$\begin{matrix}[ Math . 3 ] & \\ {f}_{T} = \frac{{C}_{p}}{2 T} & ( 3 )\end{matrix}$$

$$\begin{matrix}[ Math . 4 ] & \\ {f}_{{T}^{′}} = \frac{{C}_{p}}{2 ( T + Δ T )} & ( 4 )\end{matrix}$$

$$\begin{matrix}[ Math . 5 ] & \\ {f}_{void} = \frac{{C}_{p}}{2 d} & ( 5 )\end{matrix}$$

When ΔT/T=α (>0) is a rate of a distance increased due to the bypass, the peak frequency f_{T′} of the multi-reflection on the opposite surface bypassing the void is expressed as in the following Formula (6).

$$\begin{matrix}[ Math . 6 ] & \\ {f}_{{T}^{′}} = \frac{{C}_{p}}{2 ( T + Δ T )} = \frac{1}{2 T} \cdot \frac{{C}_{p}}{1 + α} & ( 6 )\end{matrix}$$

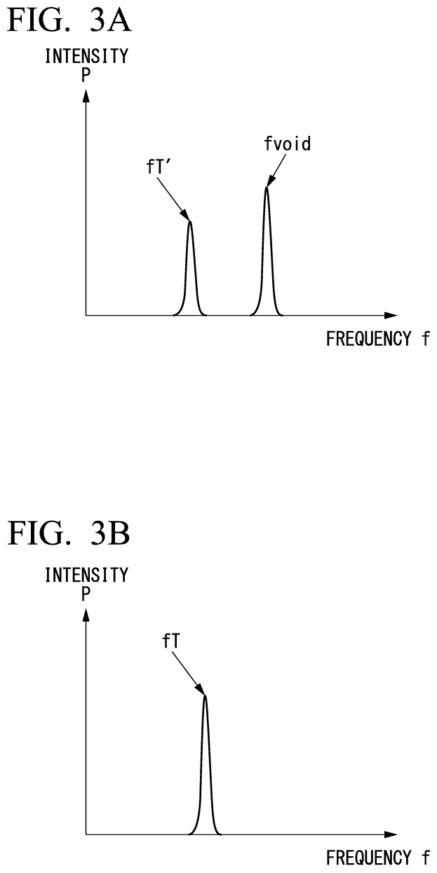

In the plate thickness mode, a speed appears to decrease from Cₚ to Cₚ/((1+α)). As a result, frequency spectra at the measurement points A and B are obtained as in FIGS. 3A and 3B. FIGS. 3A and 3B illustrate examples of frequency spectra at the measurement points A and B. FIG. 3A illustrates a frequency spectrum at the measurement point A and FIG. 3B illustrates a frequency spectrum at the measurement point B.

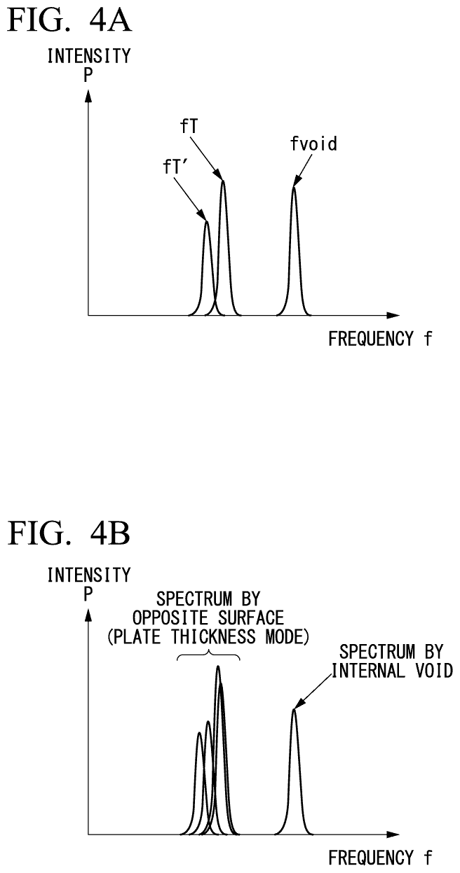

When the frequency spectrum at the measurement point A illustrated in FIG. 3A and the frequency spectrum at the measurement point B illustrated in FIG. 3B overlap, a frequency spectrum in FIG. 4A is obtained. An image in which frequency spectra observed at more measurement points overlap is illustrated in FIG. 4B.

As illustrated in FIGS. 4A and 4B, as a result, in the frequency spectrum in the plate thickness mode, peak positions of the frequency spectrum vary due to an influence of an internal void or the like. In a multi-reflection spectrum due to an internal void, a change in speed is small and a variation in peak positions is also small since bypass does not occur. A difference in the distribution makes it possible to specify a frequency range of the plate thickness mode. In the speed estimation apparatus according to the embodiment, a frequency spectrum is first obtained based on a vibration waveform observed at one measurement point and one or more peak frequencies are extracted from the obtained frequency spectrum. Further, the speed estimation apparatus calculates a peak frequency incidence distribution based on results obtained by extracting the peak frequencies at a plurality of measurement points and specifies a plate thickness mode frequency range indicating a range of a frequency corresponding to the plate thickness mode. A specific procedure for specifying the plate thickness mode frequency range will be described below.

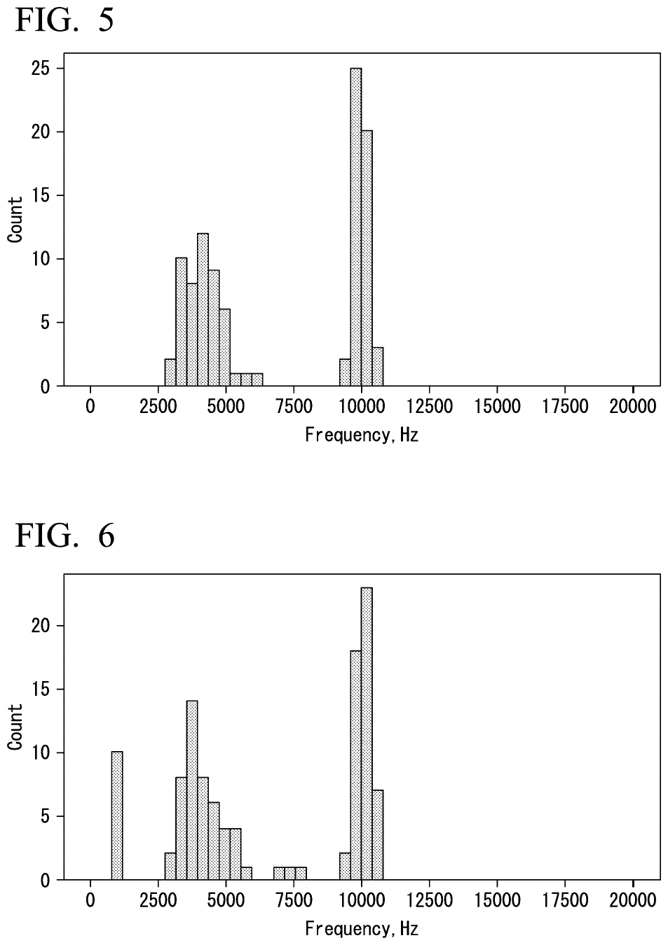

Here, to facilitate description, results obtained by a Monte Carlo simulation of 50 samples in which a speed and a bypass coefficient α were randomly varied at an average speed of 4000 m/s on the assumption of a thickness of 0.4 m and an internal void located at a location of 0.2 m will be described. A peak frequency incidence distribution in this case is illustrated in FIG. 5. FIG. 5 illustrates an example of a peak frequency incidence distribution obtained by a simulation in which a reduction in a speed due to an internal void is modeled. It is understood that frequency spectra due to internal voids are concentrated near about 10 kHz and a frequency spectrum in the plate thickness mode is distributed at 2500 to 6000 Hz. The frequency spectrum in the plate thickness mode has a larger dispersion than the frequency spectra due to the internal voids because of an influence of a variation in speed due to the bypass. Based on the point, the speed estimation apparatus obtains an incidence distribution of the peak frequencies and estimates that a set of lower frequencies shows to the plate thickness mode when a multimodal distribution having a plurality of peaks is shown.

On the other hand, when there are voids (for example, “delaminations in concrete” or the like) at shallower locations, as illustrated in FIG. 6, peaks at lower frequencies occur (which is referred to as a flexural mode). In FIG. 6, peaks occurring at locations less than 2500 Hz show the flexural mode. In this case, a set of lowest frequencies does not show the plate thickness mode and estimation is likely to be erroneous. Accordingly, the speed estimation apparatus can determine that the plate thickness mode frequency range is a range of 2500 to 6000 Hz by determining a set of largest dispersions as the plate thickness mode in a set of the plurality of distributions. In this way, even when internal voids and flexural vibration coexist, a frequency range of the plate thickness mode can be specified accurately.

### (Calculation of Elastic Wave Speed at Each Measurement Point)

Here, a case in which a frequency in the plate thickness mode at each measurement point is specified based on the frequency range of the plate thickness mode will be described. Here, at a certain measurement point Mᵢ (where i is an identifier in i=0, 1, . . . , (N−1) when the number of measurement points is N), the speed estimation apparatus determines a peak frequency with largest amplitude in a frequency range (for example, 2500 to 6000 Hz) of the plate thickness mode obtained by the above-described method as a frequency f_{Ti} at a measurement point Mᵢ. Here, when there is no peak frequency in the determined frequency range of the plate thickness mode, the speed estimation apparatus may determine a peak closest to the lower limit of the frequency range of the plate thickness mode to a plate thickness mode frequency f_{Ti}. At this time, since the plate thickness T is known, an elastic wave speed Cₚᵢ at the measurement point Mᵢ can be calculated from the relationship of the above Formula (1).

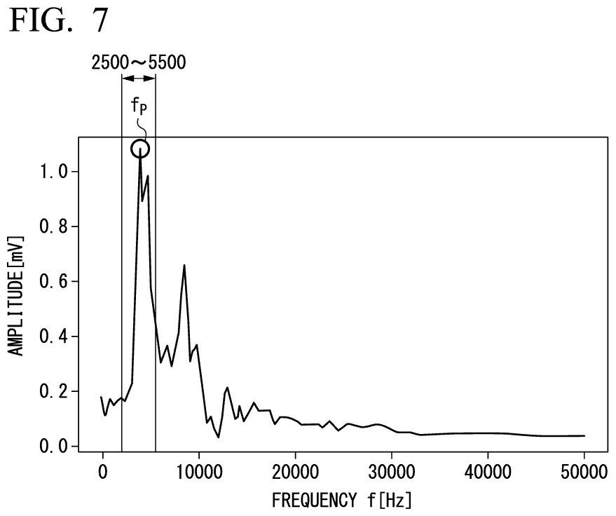

For example, the frequency spectra obtained at the measurement points illustrated in FIG. 1 will be described as an example with reference to FIG. 7. FIG. 7 illustrates a method of determining a peak frequency in a frequency range of the plate thickness mode. As illustrated in FIG. 7, the speed estimation apparatus determines a peak frequency f_{P} with the largest amplitude in a frequency range (for example 2500 to 6000 Hz) of the plate thickness mode as the frequency f_{T} of the plate thickness mode at a certain measurement point in the frequency spectrum obtained at the certain measurement point. The speed estimation apparatus performs a similar process at the frequency spectrum obtained at each measurement point. The frequency range of the plate thickness mode at any measurement point is the same.

### (Elastic Wave Speed Distribution)

As described above, the elastic wave speeds in a plate thickness direction at the plurality of measurement points M can be calculated. Since the positions of the measurement points are known, a 2-dimensional map in which the elastic wave speeds in the plate thickness direction at the measurement points are representative values (elastic wave speed distribution) can be drawn. At this time, by appropriately approximating spaces between the measurement points, it is possible to draw a spatially continuous speed distribution.

The above flow is a flow of a process according to the method of estimating the speeds according to the embodiment. Hereinafter, a specific configuration for realizing the above process will be described.

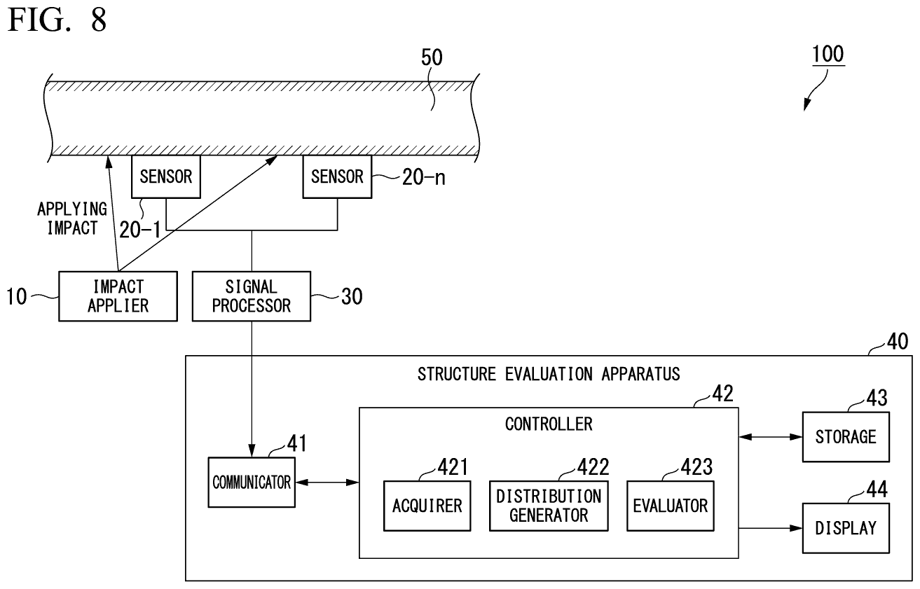

FIG. 8 illustrates a configuration of a structure evaluation system 100 according to an embodiment. The structure evaluation system 100 is used to estimate soundness of a structure 50. In the following description, evaluation means that the degree of soundness of the structure 50, that is, a deterioration state of the structure 50, is determined based on a certain standard.

In the following description, a case in which the structure 50 is a bridge will be described as an example. The structure 50 may not be limited to a bridge. The structure 50 may be any type of structure as long as elastic waves are generated due to crack formation or propagation or an external impact (for example, rain, artificial rain, or the like). A bridge is not limited to a structure bult over a river or a valley and also includes any of various structures (for example, an elevated highway) erected above a ground level. The structure may be a plate-like member.

Examples of damage that affects evaluation of the deterioration state of the structure 50 include damage of interfere with propagation of elastic waves, such as racks, cavities, and soil-like degradation. Here, cracks include vertical cracks, horizontal cracks, and diagonal cracks. The vertical cracks are cracks occurring in the vertical direction to a road surface. The horizontal cracks are cracks occurring in the horizontal direction to a road surface. The diagonal cracks are cracks occurring in directions to a road surface other than the horizontal and vertical directions. The soil-like degradation is deterioration where concrete changes to a soil-like state mainly at the boundary between asphalt and concrete slabs.

The structure evaluation system 100 includes an impact applier 10, a plurality of sensors 20-1 to 20-n (where n is an integer of 2 or more), a signal processor 30, and a structure evaluation apparatus 40. Each of the plurality of sensors 20-1 to 20-n and the signal processor 30 are connected to be able to communicate with each other in a wired manner. The signal processor 30 and the structure evaluation apparatus 40 are connected to be able to communicate with each other in a wired or wireless manner. In the following description, the sensors 20-1 to 20-n are referred to as the sensors 20 when the sensors 20-1 to 20-n are not distinguished from each other.

The impact applier 10 is installed on, for example, the same surface as a surface on which the sensors 20 are installed and applies an impact to the structure 50. The impact applier 10 applies an impact to the structure 50, for example, by striking the structure 50. A method of causing the impact applier 10 to apply an impact to the structure 50 is not limited to this method and another method may be used as long as the method is a method capable of applying an impact to the structure 50. The impact applier 10 may be installed on a surface different from the surface on which the sensors 20 are installed. The surface different from the surface on which the sensors 20 are installed is, for example, an opposite surface to the surface on which the sensors 20 are installed, a side surface of the structure 50, or the like.

It is preferable that a user can move the impact applier 10 to apply an impact to a plurality of locations. Each of the plurality of locations to which the impact applier 10 applies the the impact is the above-described measurement point. Since the plurality of locations to which the impact applier 10 applies the the impact can be set freely, the position of the measurement points are known.

The sensor 20 includes a piezoelectric element and detects an elastic wave reflected in the inside or an end surface of the structure 50. The sensors 20 are installed at positions at which sensors 20 can detect the elastic waves on the surface of the structure 50. For example, the sensors 20-1 to 20-n are installed to be spaced at equal or different intervals on a road surface, a side surface, or a bottom surface in a vehicle travel axis direction and a direction perpendicular to a vehicle travel axis. The vehicle travel axis direction indicates a direction in which a vehicle travels on a road surface. The direction perpendicular to the vehicle travel axis indicates a direction perpendicular to the vehicle travel axis direction. The sensors 20 convert the detected elastic waves into electric signals. In the following description, a case in which the sensors 20 are installed on the bottom surface of the structure 50 will be described as an example.

In the sensor 20, a piezoelectric element that has sensitivity in the range of, for example, 10 kHz to 1 MHz is used. There are types of sensor 20 including a resonant type of sensor with a resonant peak within a frequency range and a broadband type of sensor suppressing resonance, but any type of sensor 20 may be used. Methods in which the sensors 20 detect elastic waves include a voltage output type, a resistant change type, and a capacitive type of sensors, but any type of detection method may be used.

Instead of the sensors 20, acceleration sensors may be used. In this case, the acceleration sensors detect elastic waves generated inside the structure 50. The acceleration sensors convert the detected elastic waves into electric signals by performing a similar process to that of the sensors 20.

The signal processor 30 is an example of the above-described speed estimation apparatus. The signal processor 30 receives an input of the electric signals output from the sensors 20. The signal processor 30 performs signal processing on the input electric signals. The signal processing performed by the signal processor 30 is, for example, spectrum extraction, peak frequency extraction, determination of a frequency range in the plate thickness mode, specifying of a peak frequency at each measurement point, estimation of a speed of an elastic wave, or the like. The signal processor 30 may perform noise removing, extraction of features of elastic waves, or the like. The signal processor 30 generates transmission data including positional information of each measurement point obtained through the signal processing and information regarding the speeds of the elastic waves at each measurement point. For the positional information of each measurement point, positional information of a target measurement point is assumed to be input to the signal processor 30 before the measurement of each measurement point is started. Therefore, the positional information of each measurement point is known.

The signal processor 30 outputs the generated transmission data to the structure evaluation apparatus 40. When a speed of the elastic wave at one measurement point is estimated, the signal processor 30 may transmit the transmission data including the information regarding the estimated speed of the elastic wave at the measurement point to the structure evaluation apparatus 40. When speeds of the elastic waves at a predetermined number of measurement points are estimated, the signal processor 30 may transmit the transmission data including the information regarding the estimated speeds of the plurality of elastic waves at the predetermined number of measurement points to the structure evaluation apparatus 40.

The signal processor 30 is configured with a digital circuit. The digital circuit is realized by, for example, a field programmable gate array (FPGA) or a microcomputer. The digital circuit may be realized by a dedicated large-scale integration (LSI) circuit. In the signal processor 30, a nonvolatile memory such as a flash memory or a detachable memory may be mounted. In the following description, a case in which the signal processor 30 is configured with a digital circuit will be described.

The structure evaluation apparatus 40 evaluates a deterioration state of the structure 50 based on the information regarding the speed of the elastic wave at each of the plurality of measurement points included in the transmission data transmitted from the signal processor 30. For example, the structure evaluation apparatus 40 generates an elastic wave propagation speed distribution based on the information regarding the speed of the elastic wave at each of the plurality of measurement points and evaluates a deterioration state of the structure 50 based on the generated elastic wave propagation speed distribution. The elastic wave propagation speed distribution indicates a distribution in which propagation speeds of the elastic waves generated in the structure 50 are shown. For example, the elastic wave propagation speed distribution may be illustrated in a contour diagram. The structure evaluation apparatus 40 is configured with an information processing apparatus such as a personal computer.

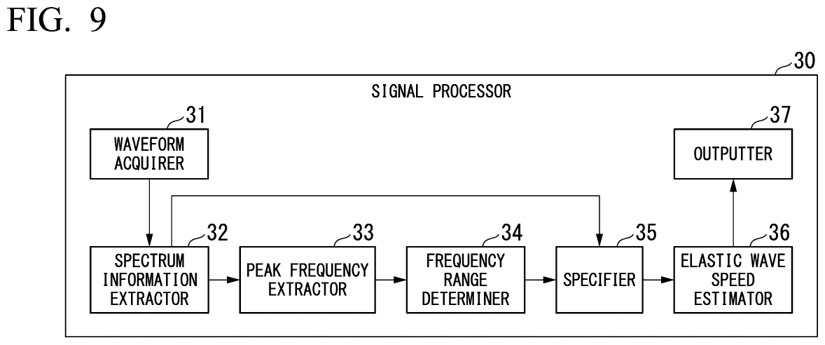

FIG. 9 illustrates a configuration example of the signal processor 30 according to the embodiment. The signal processor 30 includes a waveform acquirer 31, a spectrum information extractor 32, a peak frequency extractor 33, a frequency range determiner 34, a specifier 35, an elastic wave speed estimator 36, and an outputter 37.

The waveform acquirer 31 is configured with an amplifier, an analog filter, and an analog-to-digital converter. The amplifier amplifies an electric signal (analog signal) output from the sensor 20 to the degree that the electric signal can be processed by the analog-to-digital converter. The amplifier outputs the amplified electric signal to the analog filter. The analog filter removes a noise component other than a predetermined band. The analog filter is, for example, a band pass filter (BPF). As the band pass filter used here, it is preferable to use a filter that has a sufficiently large pass bandwidth to the degree that a shape of an elastic wave (AE signal) is not distorted. The electric signal from which noise is removed by the analog filter is input to the analog-to-digital converter. The analog-to-digital converter quantizes the electric signal from which noise is removed to convert the electric signal into a digital signal. The analog-to-digital converter outputs waveform data that is the digital signal to the spectrum information extractor 32.

The spectrum information extractor 32 converts the waveform data into data of a frequency domain by performing FFT on the waveform data output from the waveform acquirer 31. Accordingly, it is possible to extract information regarding the frequency spectrum included in the waveform data. In this way, for each measurement point, the spectrum information extractor 32 extracts the spectrum information of one or more elastic waves generated due to an impact on different measurement points in the structure 50. Hereinafter, information regarding the frequency spectrum extracted by the spectrum information extractor 32 is referred to as frequency spectrum information. The peak frequency extractor 33 extracts a plurality of frequencies with relatively prominent peaks (peak frequencies) from the frequency spectrum information extracted by the spectrum information extractor 32. In the extraction of the peak frequencies, any of various algorithms is used, but the present invention is not particularly limited thereto. For example, as a simple method, an algorithm for searching for a point at which a difference in intensity between adjacent frequencies is 0 in the frequency spectrum information can be applied. The peak frequency extractor 33 performs this process on the waveform data based on the elastic waveforms obtained at a plurality of measurement points. Accordingly, the peak frequency extractor 33 can extract a plurality of peak frequencies in each piece of spectrum information extracted at each measurement point. The peak frequency extractor 33 generates a peak frequency list in which all the peak frequencies are integrated. The peak frequency list is a list in which information regarding an incidence (the number of times) extracted as the peak frequencies is registered in association with frequencies.

The frequency range determiner 34 calculates an incidence distribution of the peak frequency based on the peak frequency list generated by the peak frequency extractor 33. The frequency range determiner 34 specifies a plate thickness mode frequency range corresponding to the plate thickness mode based on the calculated incidence distribution of the peak frequencies. The frequency range determiner 34 may set, for example, a range of the frequencies in which a set of lower frequencies is located as the plate thickness mode frequency range or may set a range of frequencies in which a set of largest dispersions is located as the plate thickness mode frequency range. The frequency range that is one set may be set in advance or may be a range until the number of counts of the peak frequencies near a peak frequency included in one set becomes a value less than a threshold. The frequency range determiner 34 is a type of range determiner.

The specifier 35 specifies the plate thickness mode frequency range at each measurement point based on the frequency spectrum information at each measurement point extracted by the spectrum information extractor 32 and the plate thickness mode frequency range determined by the frequency range determiner 34. Specifically, the specifier 35 determines a peak with largest amplitude in the plate thickness mode frequency range determined by the frequency range determiner 34 as a plate thickness mode frequency f_{Ti} in the frequency spectrum information that is based on an elastic wave obtained at a certain measurement point Mᵢ. When there is no peak frequency in the plate thickness mode frequency range, the specifier 35 may determine a peak closest to a lower limit of the plate thickness mode frequency range as the plate thickness mode frequency f_{Ti}. The specifier 35 determines a plate thickness mode frequency f_{T} at all the measurement points M.

The elastic wave speed estimator 36 estimates the elastic wave speed Cₚᵢ at the measurement point Mᵢ based on the above Formula (1) using the plate thickness mode frequency f_{Ti} in the measurement point Mᵢ specified by the specifier 35 and the known plate thickness T. The elastic wave speed estimator 36 estimates the elastic wave speed Cₚ at all the measurement points by performing this process at all the measurement points.

The outputter 37 generates transmission data including the elastic wave speed Cₚ at a plurality of measurement points estimated by the elastic wave speed estimator 36. The outputter 37 transmits the generated transmission data to the structure evaluation apparatus 40 in a wired or wireless manner.

FIG. 8 is referred to for description. The structure evaluation apparatus 40 includes a communicator 41, a controller 42, a storage 43, and a display 44.

The communicator 41 receives one or more pieces of transmission data transmitted from the signal processor 30.

The controller 42 controls the entire structure evaluation apparatus 40. The controller 42 is configured with a processor such as a central processing unit (CPU) or a memory. The controller 42 functions as an acquirer 421, a distribution generator 422, and an evaluator 423 by executing a program.

Some or all of the functional units of the acquirer 421, the distribution generator 422, and the evaluator 423 may be realized by hardware such as an application specific integrated circuit (ASIC), a programmable logic device (PLD), or an FPGA or may be realized by software and hardware in cooperation. A program may be recorded on a computer-readable recording medium. The computer-readable recording medium is, for example, a portable medium such as a flexible disc, a magneto-optical disc, a read only memory (ROM), or a CD-ROM, or a non-transitory storage medium such as a storage device such as a hard disk contained in a computer system. The program may be transmitted via an electric communication line.

Some of the acquirer 421, the distribution generator 422, and the evaluator 423 may not be mounted in advance in the structure evaluation apparatus 40 and may be realized by installing an additional application program in the structure evaluation apparatus 40.

The acquirer 421 acquires various types of information. The acquirer 421 acquires one more pieces of transmission data received by, for example, the communicator 41. The acquirer 421 stores the one or more pieces of acquired data in the storage 43.

The distribution generator 422 generates an elastic wave propagation speed distribution based on one or more pieces of transmission data stored in the storage 43. Specifically, the distribution generator 422 generates the elastic wave propagation speed distribution by recording elastic wave speeds at known measurement points as elastic wave speeds at measurement point coordinates. When (x, y) are 2-dimensional coordinates at a certain measurement point, matrix data of (x, y, z) at an elastic speed z at the position (x, y) can be recorded. The distribution generator 422 may output the matrix data as a numerical value or may also express the matrix data as a diagram that is a contour line or a heatmap. When the matrix data is displayed as a diagram, it is useful to obtain estimated values at coordinates other than the measurement points by interpolating the speed at the coordinates other than the measurement point using any of various interpolation techniques such as linear interpolation, polynomial interpolation, and spline interpolation.

The evaluator 423 evaluates a deterioration state of the structure 50 based on the elastic wave propagation speed distribution generated by the distribution generator 422. For example, the evaluator 423 evaluates a region where the elastic wave speed in the elastic wave propagation speed distribution is less than a predetermined threshold as a deterioration region. The evaluator 423 evaluates a region where an elastic wave speed in the elastic wave propagation speed distribution is equal to or greater than the predetermined threshold as a sound region. The sound region is a region where damage does not occur inside the structure 50 or damage is relatively small even when the damage does occurs inside the structure 50.

The evaluator 423 may evaluate the structure 50 as follows. For example, the evaluator 423 divides the elastic wave propagation speed distribution into two regions such as a region where a propagation speed is high and a region where the propagation speed is low based on a standard value related to a propagation speed of the elastic wave (hereinafter referred to as a “propagation speed standard value”). Specifically, the evaluator 423 divides the elastic wave propagation speed distribution into the regions by binarizing the elastic wave propagation speed distribution based on the propagation speed standard value. In the embodiment, for example, the propagation speed standard value is set to 3800 m/s. The evaluator 423 divides the elastic wave propagation speed distribution into the regions by binarizing a region where the propagation speed is equal to or greater than the propagation speed standard value (3800 m/s) as a region where the propagation speed is high and binarizing a region where the propagation speed is less than the propagation speed standard value (3800 m/s) as a region where the propagation speed is low. The propagation speed standard value may not be limited to the above value and may be appropriately changed. The evaluator 423 may devaluate the region where the propagation speed is high as a sound region and may evaluate the region where the propagation speed is low as a deterioration region.

The storage 43 stores one or more pieces of transmission data acquired by the acquirer 421. The storage 43 is configured with a storage device such as a magnetic hard disk device or a semiconductor storage device. The storage 43 may store an evaluation result obtained by the evaluator 423.

The display 44 displays the evaluation result under the control of the evaluator 423. For example, the display 44 may display, as the evaluation result, whether deterioration occurs inside the structure 50 or may display a region where deterioration occurs on the elastic wave propagation speed distribution. The display 44 is an image displace device such as a liquid crystal display, an organic electroluminescence (EL) display. The display 44 may be an interface for connecting the image display device to the structure evaluation apparatus 40. In this case, the display 44 generates a video signal for displaying the evaluation result and outputs the video signal to an image display apparatus connected to the own apparatus.

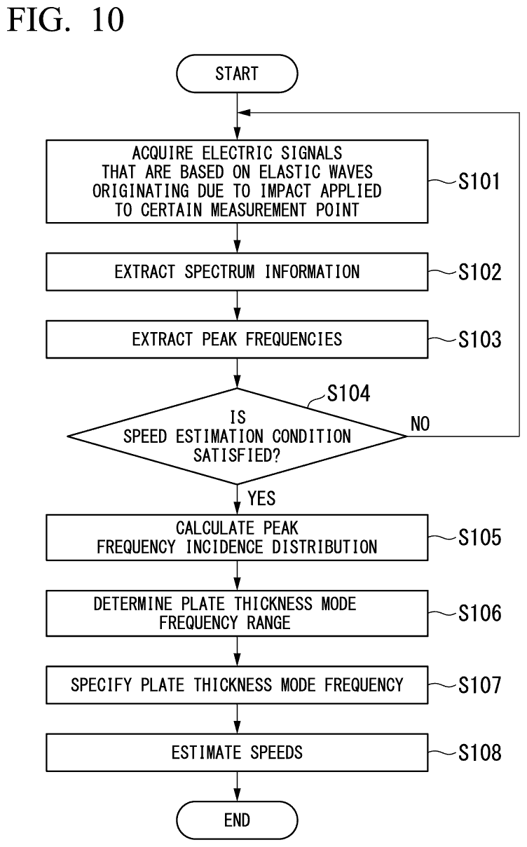

FIG. 10 illustrates a flow of a speed estimation process performed by the signal processor 30 according to the embodiment. The process of FIG. 10 is performed when an impact is applied at a certain measurement point and an elastic wave is detected by the sensor 20.

The waveform acquirer 31 acquires electric signals that are based on the elastic waves generated due to an impact applied to a certain measurement point when the electric signals are output from the sensors 20. The waveform acquirer 31 acquires waveform data at the measurement point by performing signal amplification, filter processing, and analog-to-digital conversion on the acquired electric signals (step S101). The waveform acquirer 31 outputs the acquired waveform data to the spectrum information extractor 32.

The spectrum information extractor 32 extracts the frequency spectrum information by performing the FFT on the waveform data at the measurement point output from the waveform acquirer 31 (step S102). Accordingly, the spectrum information extractor 32 extracts, for example, the frequency spectrum information illustrated in FIG. 1. The spectrum information extractor 32 outputs the extracted frequency spectrum information at the measurement point to the peak frequency extractor 33 and the specifier 35. The peak frequency extractor 33 extracts one or more peak frequencies based on the frequency spectrum information output from the spectrum information extractor 32 (step S103). The peak frequency extractor 33 registers information regarding the extracted one or more peak frequencies in the peak frequency list. For example, when the extracted peak frequencies are fₜ₁ and fₜ₂, the peak frequency extractor 33 adds 1 to a value of the incidence associated with the frequencies fₜ₁ and fₜ₂ of the peak frequency list.

The signal processor 30 determines whether a speed estimation condition is satisfied (step S104). The speed estimation condition is a condition for starting estimation of the propagation speeds of the elastic waves and may be, for example, a condition that the frequency spectrum information corresponding to a predetermined number of measurement points (at least two or more measurement points). When signal processor 30 determines that the speed estimation condition is not satisfied (NO in step S104), the signal processor 30 repeatedly performs processes subsequent to step S101. In this case, the user moves the impact applier 10 to other measurement points to apply an impact to the other measurement points. Accordingly, the elastic waves are generated at the other measurement points. By repeatedly performing the processes from step S101 to S103, it is possible to obtain the frequency spectrum information at the plurality of measurement points.

When the signal processor 30 determine that the speed estimation condition is satisfied (YES in step S104), the frequency range determiner 34 calculates the peak frequency incidence distribution with reference to the peak frequency list (step S105). The frequency range determiner 34 specifies the plate thickness mode frequency range corresponding to the plate thickness mode based on the calculated peak frequency incidence distribution (step S106). The frequency range determiner 34 outputs the information indicating the specified plate thickness mode frequency range to the specifier 35. The specifier 35 specifies the plate thickness mode frequency at each measurement point based on the spectrum information of each measurement point output from the spectrum information extractor 32 and information indicating the plate thickness mode frequency range output from the frequency range determiner 34 (step S107).

Specifically, the specifier 35 determines a peak frequency with the largest amplitude within the plate thickness mode frequency range at each piece of the spectrum information of each measurement point output from the spectrum information extractor 32. Accordingly, the specifier 35 determines the peak frequency with the largest amplitude within the plate thickness mode frequency range for each measurement point. The specifier 35 specifies the peak frequency determined for each measurement point at the plate thickness mode frequency at each measurement point. The specifier 35 outputs the information indicating the specified plate thickness mode frequency at each measurement point to the elastic wave speed estimator 36.

The elastic wave speed estimator 36 estimates the elastic wave speed Cₚ at each measurement point based on the above Formula (1) using the information indicating the plate thickness mode frequency at each measurement point output from the specifier 35 (step S108). The elastic wave speed estimator 36 outputs information indicating the estimated elastic wave speed Cₚ at each measurement point in association with the information indicating the position of each measurement point to the outputter 37. The outputter 37 generates the transmission data including the information output from the elastic wave speed estimator 36 and outputs the transmission data to the structure evaluation apparatus 40.

In the structure evaluation system 100 that has the above configuration, the signal processor 30 includes: the spectrum information extractor 32 that extracts the spectrum information of one or more elastic waves generated due to an impact at different measurement points of the structure 50 for each measurement point; the peak frequency extractor 33 that extracts one or more peak frequencies in each piece of spectrum information extracted for each measurement point; the frequency range determiner 34 that determines the frequency range (the frequency range of the plate thickness mode) of the elastic waves reflected on the opposite surface to the surface to which an impact is applied based on the one or more peak frequencies obtained for each measurement point; the specifier 35 that specifies the peak frequency at each measurement point based on the spectrum information extracted for each measurement point and the frequency range; and the elastic wave speed estimator 36 that estimates the elastic wave speed at each measurement point based on the peak frequency specified for each measurement point by the specifier 35 and the thickness information of a target member.

As described above, by determining the frequency range of the plate thickness mode based on one or more peak frequencies obtained for each measurement point, it is possible to exclude the frequencies of the elastic waves reflected due to damage in the inside such as a void of the structure 50. Accordingly, it is possible to specify the peak frequencies of the elastic waves corresponding to the known plate thickness. Accordingly, it is possible to estimate the propagation speed with high accuracy based on the specified peak frequencies of the elastic waves corresponding to the known plate thickness. Therefore, it is possible to improve estimation accuracy of the elastic wave speeds.

Further, the frequency range determiner 34 calculates the peak frequency incidence distribution representing an incidence of peak frequencies by adding up the one or more peak frequencies obtained for each of the measurement points and determines a frequency range of the plate thickness mode based on the calculated peak frequency incidence distribution. Accordingly, it is possible to determine the frequency range of the plate thickness mode based on the peak frequency incidence.

Further, the frequency range determiner 34 determines a set of largest dispersions as the frequency range of the plate thickness mode in the peak frequency incidence distribution. As described above, in the frequency spectrum of the elastic waves of the plate thickness mode, peak positions of the frequency spectrum vary since bypass occurs due to an influence of an internal void or the like. On the other hand, in the frequency spectrum of the elastic wave reflected due to an internal void, a change in speed is small and a variation in peak positions is also small since bypass does not occur. By determining the set of the largest dispersions as the frequency range of the plate thickness mode based on this viewpoint, it is possible to easily specify the frequency range of the plate thickness mode. In particular, according to the determination method, it is possible to easily determine the frequency range of the plate thickness mode even when a peak of the lower frequency called the flexural mode occurs.

Further, the frequency range determiner 34 determines a set of lowest frequencies as the frequency range of the plate thickness mode in the peak frequency incidence distribution. As described above, the frequency spectrum due to an internal void appears at a higher position than the frequency spectrum by the plate thickness mode in many cases. Accordingly, by determining the set of the lower frequencies as the frequency range of the plate thickness mode, it is possible to easily specify the frequency range of the plate thickness mode.

### Modified Example 1

In each of the embodiments, the configuration in which the plurality of sensors 20-1 to 20-n are connected to one signal processor 30 has been described. The structure evaluation system 100 may include a plurality of signal processors 30 and each of the sensors 20 may be connected to a different signal processor 30. In this case, the plurality of signal processors 30 estimates an elastic wave speed based on an elastic wave detected by each of the connected sensors 20.

### Modified Example 2

Some or all of the functional units included in the structure evaluation apparatus 40 may be included in another apparatus. For example, the display 44 included in the structure evaluation apparatus 40 may be included in another apparatus. In the case of this configuration, the structure evaluation apparatus 40 transmits an evaluation result to the other apparatus including the display 44. The other apparatus including the display 44 displays the received evaluation result.

### Modified Example 3

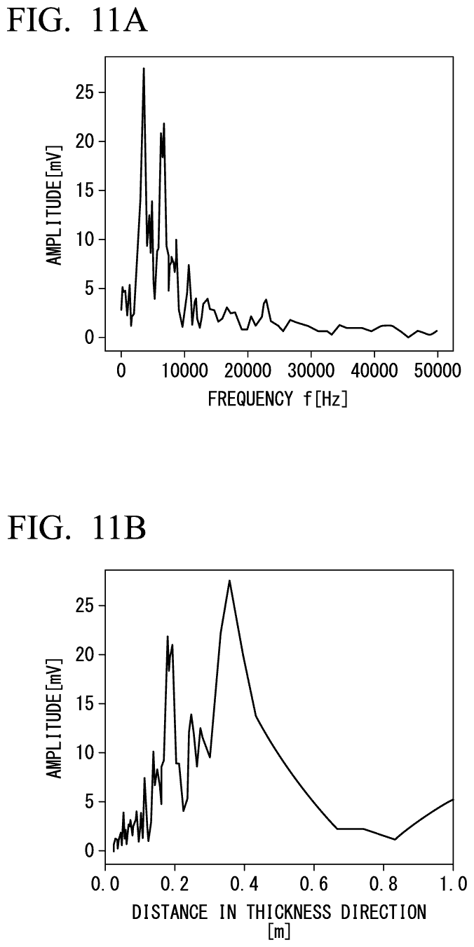

The signal processor 30 may include a converter that converts the frequency axis in the frequency spectrum obtained at each measurement point into information regarding a depth direction (a thickness direction of a structure). In the case of this configuration, the converter converts the frequency axis in the frequency spectrum obtained at each measurement point into the information regarding the depth direction (the thickness direction of the structure) by converting the frequency axis f in the spectrum of the measurement point Mᵢ into a thickness direction distance d based on a relationship of f=Cₚᵢ/2d using the elastic wave speed Cₚᵢ at the measurement point Mᵢ. FIGS. 11A and 11B illustrate a result obtained by converting the frequency axis in the frequency spectrum obtained at a certain measurement into information regarding a depth direction (the thickness direction of a structure). FIG. 11A illustrates a frequency spectrum obtained at a certain measurement point and FIG. 11B illustrates a result obtained by converting the frequency axis into the information regarding the depth direction (the thickness direction of the structure).

The converter converts the elastic wave speeds Cₚ obtained at all the measurement points into information regarding the depth direction (the thickness direction of the structure). The outputter 37 generates transmission data including the information regarding the depth direction at the plurality of measurement points converted by the converter. The outputter 37 transmits the generated transmission data to the structure evaluation apparatus 40 in a wired or wireless manner.

The distribution generator 422 of the structure evaluation apparatus 40 generates a depth direction reflection intensity distribution indicated by information regarding reflection intensity in the depth direction by recording information regarding the depth direction at known measurement points as a depth direction at the measurement point coordinates. Accordingly, the distribution generator 422 can obtain the reflection distribution in the thickness direction for each measurement point. The evaluator 423 evaluates a deterioration state of the structure 50 based on the depth direction reflection intensity distribution generated by the distribution generator 422. For example, the evaluator 423 can estimate a depth at which an internal void occurs. Further, for example, the evaluator 423 can also evaluate that deterioration occurs when an internal void occurs.

The evaluator 423 can also estimate a depth at which the internal void occurs based on information regarding the depth direction (the thickness direction of the structure) on the frequency axis illustrated in FIG. 11B. In the example illustrated in FIG. 11B, it can be estimated that an internal void occurs at a position of a depth of 0.2 m.

### Modified Example 4

The structure evaluation apparatus 40 may evaluate a deterioration state of the structure 50 by combining the elastic wave propagation speed distribution obtained by the above-described method and an elastic wave source density distribution. The elastic wave source density distribution indicates a distribution in which a value of density obtained in accordance with the number of elastic wave sources included in each region is shown for each predetermined region in a distribution in which generation sources of the elastic waves generated in the structure 50 are shown. In derivation of the elastic wave source density distribution, a known method is used. For example, a method of deriving an AE origin density distribution disclosed in Patent Document 1.

Further, the evaluator 423 evaluates a deterioration state of the structure 50 by combining the elastic wave propagation speed distribution and the elastic wave source density distribution according to the method disclosed in Patent Document 1. Specifically, the evaluator 423 divides the elastic wave propagation speed distribution into two regions such as a region where a propagation speed is high and a region where the propagation speed is low based on a propagation speed standard value and divides the elastic wave source density distribution into two regions such as a region where generation sources are sparse and a region where generation sources are dense based on a standard value related to density of the generation sources (hereinafter referred to as a “density standard value”). Thereafter, the evaluator 423 evaluates soundness of the structure in at least four stages in accordance with a division result of the overlapped regions by overlapping the elastic wave propagation speed distribution (binarized elastic wave propagation speed distribution) divided into two regions and the elastic wave source density distribution (binarized elastic wave source density distribution) divided into two regions. Here, specific examples of the evaluation of four stages include soundness I, soundness II, soundness III, and soundness IV.

The deterioration of a structure progress in the order of soundness I, soundness II, soundness III, and soundness IV is shown. That is, soundness I indicates least progress of the deterioration of the structure and progress of the deterioration of the structure as the soundness approaches soundness IV. Based on the evaluation condition described in Patent Document 1, the evaluator 423 evaluates to which region each region (each of the overlapped regions) of the structure corresponds among soundness I, soundness II, soundness III, and soundness IV. Soundness I corresponds to soundness described in Patent Document 1, soundness II corresponds to intermediate deterioration I described in Patent Document 1, soundness III corresponds to intermediate deterioration II described in Patent Document 1, and soundness IV corresponds to limit deterioration described in Patent Document 1. It is known that this evaluation method can be a correct evaluation index compared to a case in which two evaluation methods of the related arts are simply combined. In the embodiment, elastic wave measurement and the sensors can be commonly used. By providing a function of switching one or a plurality of a filter frequency feature, a measurement sample length, and a preamplifier gain, it is possible to acquire the elastic wave propagation speed distribution and the elastic wave source density distribution simultaneously through single measurement. Accordingly, this is appropriately used for the structure evaluation system 100 that performs evaluation using high and low elastic wave propagation speeds and dense and sparse elastic wave source density as 2-dimensional evaluation axes.

According to the at least one of the above-described embodiments, the signal processor 30 includes: the spectrum information extractor 32 that extracts spectrum information of one or more elastic waves generated due to an impact at different measurement points of the structure 50; the peak frequency extractor 33 that extracts one or more peak frequencies in each of the pieces of spectrum information extracted for each of the measurement points; the frequency range determiner 34 that determines a frequency range of the elastic waves reflected on the opposite surface to the surface to which an impact is applied based on the one or more peak frequencies obtained for each of the measurement points; the specifier 35 that specifies a peak frequency at each measurement point based on the spectrum information extracted for each of the measurement points and the frequency range; and the elastic wave speed estimator 36 that estimates an elastic wave speed at each measurement point based on the peak frequency specified for each measurement point by the specifier 35 and thickness information of the target member.

Some processes performed by the signal processor 30 according to the above-described embodiment may be realized by a computer. In this case, the processes may be realized by recording a program for realizing this function on a computer-readable recording medium and causing a computer system to read and execute the program recorded on the recording medium. The “computer system” mentioned here is assumed to include an OS and hardware such as peripheral apparatuses. The “computer-readable recording medium” refers to a portable medium such as a flexible disc, a magneto-optical disc, a ROM, or a CD-ROM or a storage device such as a hard disk contained in the computer system. Further, the “computer-readable recording medium” may also include a medium that dynamically retains a program for a short time, such as a communication line used to transmit the program via a network such as the Internet or a communication lien such as a telephone lines and a volatile memory within a server or client computer system serving as a client that retains a program for a certain time. The above program may be a program for realizing some of the above-described functions, may be a program for realizing the above-described function in combination with a program already recorded in the computer system, or may be a program realized using a programmable logic device such as an FPGA.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speed estimation apparatus comprising:
a spectrum information extractor configured to extract spectrum information of one or more elastic waves generated due to an impact at different measurement points of a target member for each measurement point;
a peak frequency extractor configured to extract one or more peak frequencies in each of the pieces of spectrum information extracted for each of the measurement points;
a range determiner configured to determine a frequency range of the elastic waves based on the one or more peak frequencies obtained for each of the measurement points;
a specifier configured to specify a peak frequency at each measurement point based on the spectrum information extracted for each of the measurement points and the frequency range; and
an elastic wave speed estimator configured to estimate an elastic wave speed at each measurement point based on the peak frequency specified for each measurement point by the specifier and thickness information of the target member.

2. The speed estimation apparatus according to claim 1, wherein the range determiner calculates a peak frequency incidence distribution representing an incidence of peak frequencies by adding up the one or more peak frequencies obtained for each of the measurement points and determines a frequency range of the elastic waves based on the calculated peak frequency incidence distribution.

3. The speed estimation apparatus according to claim 2, wherein the range determiner determines a set of largest dispersions as the frequency range of the elastic waves in the peak frequency incidence distribution.

4. The speed estimation apparatus according to claim 2, wherein the range determiner determines a set of lowest frequencies as the frequency range of the elastic waves in the peak frequency incidence distribution.

5. An evaluation system comprising:
an impact applier configured to apply an impact to different measurement points of a target member;
one or more sensors provided in the target member and configured to detect elastic waves generated due to the impact applied by the impact applier;
the speed estimation apparatus according to claim 1 configured to estimate speeds of elastic waves propagating inside the target member based on the elastic waves detected by the one or more sensors; and
an evaluation apparatus configured to evaluate a deterioration state of the target member based on the speeds of the elastic waves.

6. The evaluation system according to claim 5,
wherein the speed estimation apparatus further includes a converter that converts spectrum information of the one more elastic waves into information regarding a thickness direction of the target member based on an estimated speed of an elastic wave at each of the measurement points, and
wherein the evaluation apparatus evaluates a deterioration state of the target member based on the information regarding the thickness direction of the target member converted by the converter.

7. A speed estimation method comprising:
extracting spectrum information of one or more elastic waves generated due to an impact at different measurement points of a target member for each measurement point;
extracting one or more peak frequencies in each of the pieces of spectrum information extracted for each of the measurement points;
determining a frequency range of the elastic waves based on the one or more peak frequencies obtained for each of the measurement points;
specifying a peak frequency at each measurement point based on the spectrum information extracted for each of the measurement points and the frequency range; and
estimating an elastic wave speed at each measurement point based on the peak frequency specified for each measurement point and thickness information of the target member.
